(19) United States
(12) Patent Application Publication
(10) Pub. No.: US 2025/0172951 A1
(43) Pub. Date: May 29, 2025

(54) INFORMATION PROCESSING SYSTEM CONTROLLING MOVING OBJECT, INFORMATION PROCESSING APPARATUS, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: YUKIKO KUBO, Kanagawa (JP)

(21) Appl. No.: 18/956,142

(22) Filed: Nov. 22, 2024

(30) Foreign Application Priority Data
Nov. 28, 2023 (JP) 2023-200673

(51) Int. Cl. G05D 1/686; G05D 1/646; G05D 1/65; G05D 1/69; G05D 109/10; G05D 109/20; G05D 111/10

(52) U.S. Cl. CPC G05D 1/686; G05D 1/646; G05D 1/65; G05D 1/69; G05D 2109/10; G05D 2109/20; G05D 2111/10

(57) ABSTRACT

An information processing system that enables a mobile image capturing apparatus to reliably capture an image of a mobile object in moving. The n information processing system includes a mobile object, a mobile image capturing apparatus that captures an image of the mobile object, a memory device that stores a set of instructions, and at least one processor that executes the set of instructions to receive a detection result indicating whether the mobile object is included in an image capturing field angle of the mobile image capturing apparatus from the mobile image capturing apparatus, and issue an instruction relating to steering of at least one of the mobile object and the mobile image capturing apparatus in accordance with the detection result.

### BACKGROUND OF THE INVENTION

### Field of the Invention

The present invention relates to information processing systems, information processing apparatuses, control methods therefor, and storage media storing control programs therefor, and particularly to an information processing system, an information processing apparatus, a control method therefor, and a storage medium storing a control program therefor, which are capable of controlling a mobile image capturing apparatus and a mobile object that is an image capturing target.

### Description of the Related Art

When a landscape is captured while traveling by a car in a journey or daily life, it is a mainstream to capture the landscape by a camera attached to an inside or outside of the car. It has been difficult to capture the car while traveling together with the landscape as bird's eye view until now. However, in recent years, such a bird's-eye view image capturing has been enabled by capturing an image of a mobile object such as a car using a mobile image capturing apparatus such as a drone.

In capturing an image using a drone, flight of the drone is automatically or manually operated so that the mobile object will be included in an image capturing field angle of the drone in many cases. However, in such image capturing, there is a problem in that the drone cannot capture an image of the mobile object when the drone cannot catch up the mobile object because a speed of the mobile object is too high or when the drone loses sight of the mobile object because the mobile object is hidden by an obstacle.

As a proposal for solving such a problem, Japanese Laid-Open Patent Publication No. 2017-56903 (JP2017-56903A) proposes a technique of estimating a location of the mobile object based on information indicating a movement of the mobile object and controlling a drone toward the location.

In addition, Japanese Patent Laid-Open Publication No. 2018-201218 (JP2018-201218, related to US 20180131856A1) proposes a technique of moving a drone to a predetermined standby location designated by a control device to be in an image capturing standby state and controlling the drone to perform image capturing after waiting for an image capturing object (a mobile object) to arrive.

However, the technique of JP2017-56903A has a problem that the drone cannot catch up with the mobile object and the mobile object cannot be included in field angle of the drone when the speed of the mobile object is too fast.

In addition, the technique of JP2018-201218 has a problem that the mobile object cannot be included the image capturing field angle of the drone when the movement of the mobile object is different from a predicted movement.

### SUMMARY OF THE INVENTION

The present invention provides an information processing system, an information processing apparatus, a control method therefor, and a storage medium storing a control program therefor, which enable a mobile image capturing apparatus to reliably capture an image of a mobile object in moving.

Accordingly, an aspect of the present invention provides an information processing system including a mobile object, a mobile image capturing apparatus that captures an image of the mobile object, a memory device that stores a set of instructions, and at least one processor that executes the set of instructions to receive a detection result indicating whether the mobile object is included in an image capturing field angle of the mobile image capturing apparatus from the mobile image capturing apparatus, and issue an instruction relating to steering of at least one of the mobile object and the mobile image capturing apparatus in accordance with the detection result.

According to the present invention, the mobile object in moving can be reliably captured by the mobile image capturing apparatus.

Further features of the present invention will become apparent from the following description of exemplary embodiments with reference to the attached drawings.

### BRIEF DESCRIPTION OF THE DRAWINGS

FIG. 1 is a block diagram showing a hardware configuration of an information processing system including a mobile image capturing apparatus and a mobile object according to a first embodiment.

FIG. 2 is a block diagram showing a software configuration of an automatic traveling ECU in FIG. 1.

FIG. 3 is a flowchart schematically showing an image capturing process executed by the information processing system in the first embodiment.

FIGS. 4A, 4B, and 4C are views showing scenes of the mobile object captured by the mobile image capturing apparatus in flight and images captured in the respective scenes.

FIGS. 5A, 5B, and 5C are views showing a change example of a travel plan of the mobile object according to the first embodiment.

FIG. 6 is a block diagram showing a hardware configuration of an information processing system according to a second embodiment.

FIG. 7 is a block diagram showing a software configuration of a notice information generating ECU in FIG. 6.

FIG. 8 is a flowchart schematically showing an image capturing process executed by the information processing system in the second embodiment.

FIG. 9 is a block diagram showing a software configuration of a movement controller of the mobile image capturing apparatus.

FIG. 10 is a flowchart schematically showing an image capturing process executed by an information processing system in a third embodiment.

FIGS. 11A, 11B, and 11C are views showing a change example of a travel plan of the mobile object according to the third embodiment.

### DESCRIPTION OF THE EMBODIMENTS

Hereafter, embodiments according to the present invention will be described in detail by referring to the drawings. The following embodiments do not limit the invention according to the appended claims. Although a plurality of features are described in the embodiments, all of the plurality of features are not necessarily essential to the invention, and the plurality of features may be arbitrarily combined. Further, in the accompanying drawings, the same or similar components are denoted by the same reference numerals, and redundant descriptions are omitted.

Hereinafter, an information processing system 100 according to a first embodiment of the present invention will be described.

The information processing system 100 includes a mobile image capturing apparatus 10 (an image capturing apparatus) and a mobile object 20, and is assumed that the mobile image capturing apparatus 10 is used to capture an image of the mobile object 20 with steering equipped with an automatic traveling system. In this embodiment, the mobile image capturing apparatus 10 shall be an unmanned flying object, such as a drone flying in air by propellers. However, the mobile image capturing apparatus 10 is not limited thereto as long as it is movable. For example, the mobile image capturing apparatus may be a vehicle with wheels moving on ground or a submarine with a screw moving in water. Although an automobile is assumed as the mobile object 20 in this embodiment, the mobile object 20 is not limited thereto as long as it moves according to a passenger's steering or an instruction from the automatic traveling system. For example, the mobile object 20 may be a motorcycle, a ship, an airplane, or a train. The mobile object 20 may be operated by remote control like a radio-controlled car, without being operated by a passenger.

Hereinafter, this embodiment will be described in detail with reference to the accompanying drawings.

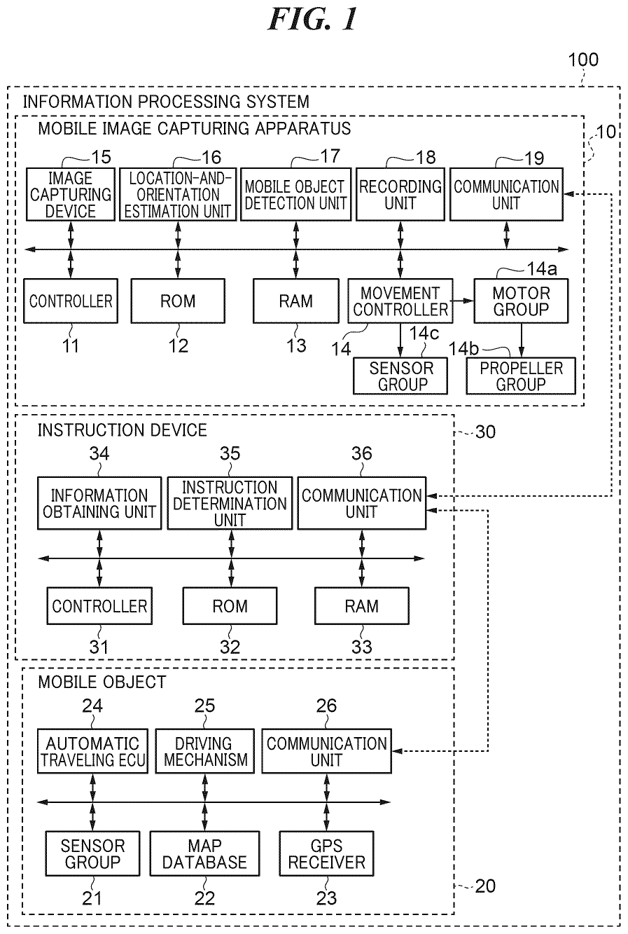

FIG. 1 is a block diagram showing a hardware configuration of the information processing system 100 according to this embodiment.

As shown in FIG. 1, the information processing system 100 includes the mobile image capturing apparatus 10, the mobile object 20, and an instruction device 30 (an information processing apparatus).

The mobile image capturing apparatus 10 includes a controller 11, a ROM 12, a RAM 13, a movement controller 14, a motor group 14a, a propeller group 14b, a sensor group 14c, an image capturing device 15, a location-and-orientation estimation unit 16, a mobile object detection unit 17, a recording unit 18, and a communication unit 19. These blocks are communicably connected to each other via a bus. The propeller group 14b includes four propellers, and the motor group 14a includes four motors. The four propellers are rotationally driven by the four motors, respectively.

The controller 11 is a CPU, for example, reads an operation program for each block included in the mobile image capturing apparatus 10 from the ROM 12, develops the operation program onto the RAM 13, and executes the operation program, so as to control the operation of each block included in the mobile image capturing apparatus 10.

The ROM 12 is an electrically erasable and recordable nonvolatile memory, and stores parameters necessary for an operation of each block in addition to the operation program for each block included in the mobile image capturing apparatus 10.

The RAM 13 is a rewritable volatile memory and is used as a temporary storage area of data output in the operation of each block included in the mobile image capturing apparatus 10.

The movement controller 14 controls a flight function of the mobile image capturing apparatus 10. In order to fly the mobile image capturing apparatus 10, it is necessary to control the motor group 14b that rotationally drives the propeller group 14a to generate power required for the flight. Therefore, the movement controller 14 controls driving forces of the motors constituting the motor group 14a to control rpms of the propellers constituting the propeller group 14b in order to control a moving direction, a location, and an orientation of the mobile image capturing apparatus 10. The movement controller 14 also obtains information such as altitude and acceleration using the sensor group 14c in order to recognize the flight state of the mobile image capturing apparatus 10. The sensor group 14c is not particularly limited as long as it can obtain the information such as altitude and acceleration. For example, the sensor group 14c may include a GPS sensor that detects GPS information, a gyrosensor that detects angular velocity, an acceleration sensor that detects acceleration, a magnetic sensor that detects a moving direction, an atmospheric pressure sensor that detects altitude, an ultrasonic sensor or a LiDAR (Light Detection And Ranging) that detects a distance to a peripheral object. In addition, the movement controller 14 transfers information relating to flight conditions from the communication unit 19 to the instruction device 30.

The image capturing device 15 includes an optical system including a zoom lens group and a focus lens group, and an image sensor that converts an image formed by the optical system into an electric signal, and applies various image processes to obtain a captured image. The obtained captured image is sent to the mobile object detection unit 17 and is recorded in the recording unit 18.

The location-and-orientation estimation unit 16 detects the image capturing location of the mobile image capturing apparatus 10. The image capturing location is detected using, for example, a flight route of the mobile image capturing apparatus 10, map information, and pieces of information (GPS information etc.) from the sensor group 14c obtained by the movement controller 14. When a destination of the mobile object 20 is set, a travel plan of the mobile object 20 to the destination is determined, and the flight route of the mobile image capturing apparatus 10 is determined accordingly.

The location-and-orientation estimation unit 16 can also estimate information about a future image capturing location based on the information about the acceleration and the moving direction obtained by the movement controller 14 from the sensor group 14c. The information about the estimated image capturing location, the acceleration and moving direction obtained, and the information about the future flight route are transferred via the communication unit 19 to the instruction device 30 as information about image capturing.

The mobile object detection unit 17 determines whether the entirety or a part of the mobile object 20, which is an image capturing object, is captured based on the image captured by the image capturing device 15. For example, a template image of the mobile object 20 is prepared, and the mobile object detection unit 17 determines whether the mobile object 20 is included in the field angle of the image capturing device 15 by performing a pattern matching between the template image and the captured image. Further, a later-described instruction determination unit 35 (an instruction unit) of the instruction device 30 determines whether it is necessary to issue an instruction regarding the steering of the mobile object based on the determination result.

The recording unit 18 is a detachable memory card or the like, and records the image processed by the image capturing device 15 as a recorded image via the RAM 13.

The communication unit 19 exchanges information with the instruction device 30. Specifically, the communication unit 19 transmits the information about the image capturing obtained from the location-and-orientation estimation unit 16 and the information about the determination result by the mobile object detection unit 17 indicating whether the mobile object 20 is included in the field angle of the captured image to the instruction device 30.

The configuration and basic operation of the mobile image capturing apparatus 10 have been described above.

Next, a configuration example of the mobile object 20 will be described with reference to FIG. 1.

The mobile object 20 is equipped with an automatic traveling system that controls the mobile object 20.

The mobile object 20 includes a sensor group 21, a map database 22, a GPS receiver 23, an automatic traveling ECU 24, a driving mechanism 25, and a communication unit 26. These blocks are communicably connected to each other via a bus.

The sensor group 21 detects peripheral information and traveling information of the mobile object 20. The peripheral information obtained from the sensor group 21 includes information about objects in the periphery of the mobile object, such as a pedestrian, a guardrail, and another preceding mobile object, which are detected using, for example, the LiDAR. Specifically, the LiDAR irradiates the periphery of the mobile object 20 with laser light, and detects a reflecting object in the periphery of the mobile object 20 by receiving reflected light. The LiDAR detects a relative distance between the object and the mobile object 20 based on a time until the laser light returns as reflected light from the detected object.

The traveling information obtained from the sensor group 21 includes, for example, traveling characteristics detected by a vehicle speed sensor, the acceleration sensor, and the information regarding operations detected by an accelerator pedal position sensor, a steering angle sensor, and a brake pedal position sensor.

The map database 22 records the map information in advance and is stored in a recording device (not shown) of the mobile object 20. The map information includes road location information, road inclination information, intersection location information, branch-point location information, building location information, and traffic rule information at each location.

The GPS receiver 23 receives signals from a plurality of GPS satellites and determines the location of the mobile object 20 based on the received signals. The location is represented by, for example, latitude and longitude. The GPS receiver 23 transmits information about the measured location of the mobile object 20 to the automatic traveling ECU 24.

The automatic traveling ECU 24 (a control unit) is an electronic controller including a CPU, a ROM, a RAM, and a CAN (Controller Area Network) communication circuit, and achieves automatic traveling by controlling hardware based on a signal output by the CPU. An example of a specific operation is as follows. The CAN communication circuit is operated to store data obtained from the sensor group 21, the map database 22, and the communication unit 26 in the RAM as input data. Thereafter, the automatic traveling ECU 24 determines a travel control signal by loading the program recorded in the ROM into the RAM and executing the program based on the input data, and transmits the determined travel control signal to the driving mechanism 25. The details of the process will be described later.

The driving mechanism 25 includes actuators for an engine, a brake, and an electric power steering and controllers therefor, and controls the driving of the mobile object 20 based on the travel control signal received from the automatic traveling ECU 24.

The communication unit 26 exchanges information with the instruction device 30. The information about the traveling characteristics and operations obtained from the sensor group 21 and the information about the location of the mobile object 20 obtained from the GPS receiver 23 are transmitted to the instruction device 30 as the traveling information. In addition, instruction information regarding the steering of the mobile object 20 is received from the instruction device 30. The communication unit 26 sends the received instruction information to the automatic traveling ECU 24 and reflects it to the travel control signal.

The configuration and basic operations of the mobile object 20 have been described above.

Next, a configuration example of the instruction device 30 will be described with reference to FIG. 1.

The instruction device 30 determines an instruction for steering the mobile object 20 based on the information received from the mobile image capturing apparatus 10 and the mobile object 20.

the instruction device 30 includes a controller 31, a ROM 32, a RAM 33, an information obtaining unit 34, an instruction determination unit 35, and a communication unit 36. These blocks are communicably connected to each other via a bus.

The controller 31 reads operation programs for the blocks included in the instruction device 30 from the ROM 32, develops the operation programs onto the RAM 33, and executes the operation programs, thereby controlling the operations of the blocks included in the instruction device 30.

The ROM 32 is an electrically erasable and recordable nonvolatile memory, and stores parameters necessary for the operations of the blocks in addition to the operation programs for the blocks included in the instruction device 30.

The RAM 33 is a rewritable volatile memory, and is used as a temporary storage area of the data output in the operations of the blocks included in the instruction device 30.

The information obtaining unit 34 stores information obtained from the communication unit 36. The obtained information includes information about the image capturing and flight obtained from the mobile image capturing apparatus 10, the traveling information obtained from the mobile object 20, etc.

The information obtained by the information obtaining unit 34 is transmitted to the instruction determination unit 35, and the instruction determination unit 35 determines an instruction related to the steering of the mobile object 20.

When the instruction determination unit 35 receives the determination result by the mobile object detection unit 17 (the determination result indicating whether the mobile object 20 is included in the field angle of the image captured by the image capturing device 15), the instruction determination unit 35 determines whether to issue the instruction related to the steering to the mobile object 20 based on the determination result. When giving the instruction related to the steering, the instruction determination unit 35 determines the instruction content based on the information obtained from the information obtaining unit 34. This process will be described later in detail. The instruction determined by the instruction determination unit 35 is then sent to the communication unit 36.

The communication unit 36 (a receiving unit) exchanges information between the mobile image capturing apparatus 10 and the mobile object 20. Specifically, the communication unit 36 receives the information from the mobile image capturing apparatus 10 and the mobile object 20, sends the information to the instruction determination unit 35, and transmits the instruction related to the steering, which is a processing result by the instruction determination unit 35, to the mobile object 20.

The configuration and basic operation of the instruction device 30 have been described above.

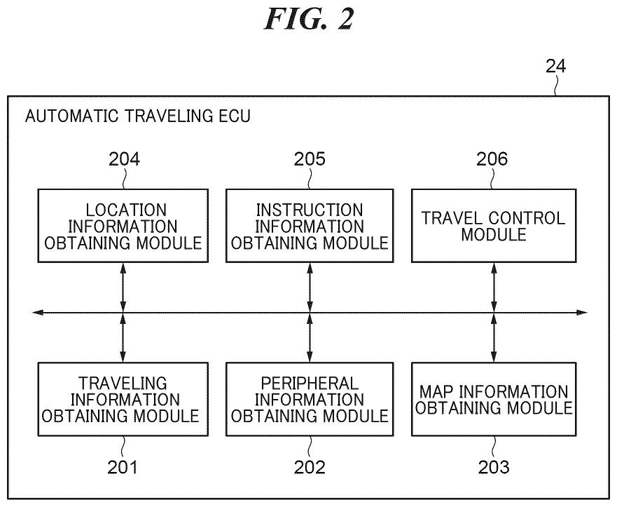

FIG. 2 is a block diagram showing a software configuration of the automatic traveling ECU 24.

In this embodiment, the automatic traveling ECU 24 includes a traveling information obtaining module 201, a peripheral information obtaining module 202, a map information obtaining module 203, a location information obtaining module 204, an instruction information obtaining module 205, and a travel control module 206.

In this embodiment, the travel control signal of the mobile object 20 is determined based on information received from the sensor group 21, the map database 22, and the communication unit 26.

The traveling information obtaining module 201 obtains the information related to the travel of the mobile object 20 obtained from the sensor group 21. Specific examples of the information obtained include information about the traveling characteristic and operation of the mobile object 20.

The peripheral information obtaining module 202 obtains the information about the periphery of the mobile object 20 obtained from the sensor group 21. Specific examples of the information obtained include determination of whether there is a peripheral object using the LiDAR, and information about a relative distance between the peripheral object and the mobile object 20 if there is the peripheral object.

The map information obtaining module 203 obtains information about the map from the map database 22.

The location information obtaining module 204 obtains information about the location of the mobile object 20 from the GPS receiver 23.

The instruction information obtaining module 205 obtains information related to the steering of the mobile object 20 from the communication unit 26. Specific examples of the information obtained include acceleration and deceleration of the mobile object 20 and a change of the route to the destination.

Then, the travel control module 206 determines a travel control signal for the mobile object 20 based on the information obtained from the sensor group 21, the map database 22, and the communication unit 26. The travel control signal determined by the travel control module 206 is transmitted to the driving mechanism 25.

Here, the operation of the automatic traveling ECU 24 and the operations of the mobile image capturing apparatus 10 and the instruction device 30 required in association with the operation of the automatic traveling ECU 24 in the image capturing process in this embodiment will be described.

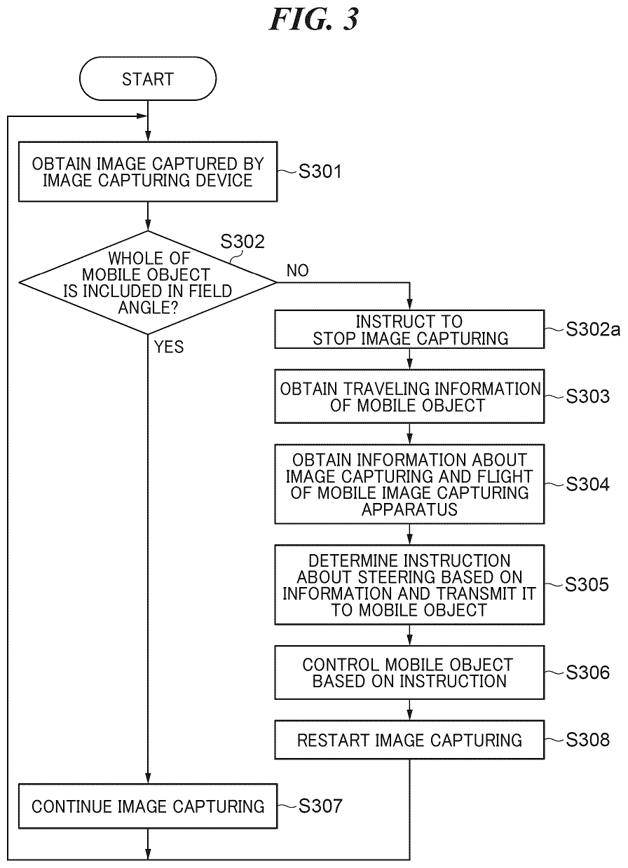

FIG. 3 is a flowchart schematically showing of the image capturing process in the information processing system 100 in this embodiment.

First, in a step S301, the mobile object detection unit 17 of the mobile image capturing apparatus 10 obtains an image captured by the image capturing device 15.

Next, in a step S302, the mobile object detection unit 17 determines whether the whole of the mobile object 20 is included in the field angle of the image capturing device 15 based on the image obtained in the step S301. As a result of the determination, when the whole of the mobile object 20 is included in the field angle (YES in the step S302), the process proceeds to a step S307. Otherwise, the process proceeds to a step S302a.

In the step S307, the mobile object detection unit 17 transmits the information indicating that the whole of the mobile object 20 is included in the field angle to the instruction device 30 via the communication unit 19. When receiving this information, the instruction determination unit 35 of the instruction device 30 determines that the image capturing desired by a user is performed, continues the image capturing, and returns the process to the step S301 after a predetermined time elapses.

On the other hand, in the step S302a, the mobile object detection unit 17 transmits the information indicating to what extent the mobile object 20 is included in the field angle (whether the mobile object 20 is partially included in the field angle or is not included at all) to the instruction device 30 via the communication unit 19. When receiving this information, the instruction determination unit 35 of the instruction device 30 determines that the user does not perform the desired image capturing and that it is necessary to issue an instruction relating to the steering to the mobile object 20, instructs the mobile image capturing apparatus 10 to stop the image capturing, and then proceeds with the process to a step S303.

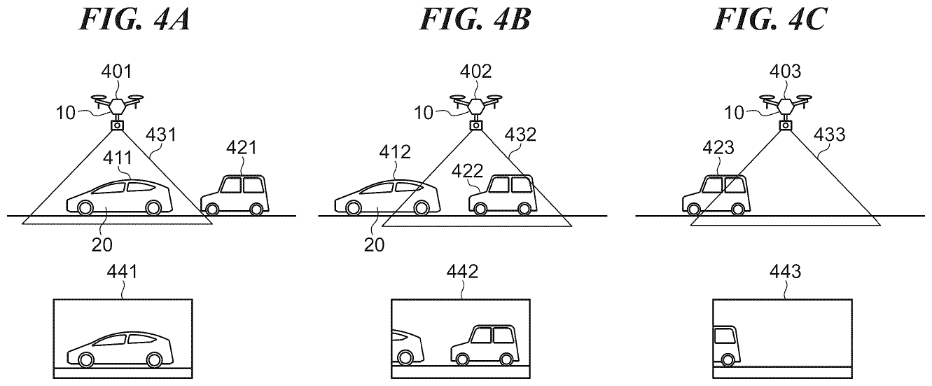

Here, the determination of the controller 31 in the steps S307 and S302a will be described using concrete examples shown in FIGS. 4A, 4B and 4C.

FIGS. 4A, 4B, and 4C are views showing image capturing scenes of the mobile object 20 captured by the mobile image capturing apparatus 10 during flight and images captured in the respective scenes.

Reference numerals 401, 402, and 403 denote locations of the mobile image capturing apparatus 10 in the respective image capturing scenes at image capturing times of t1 seconds, (t1+Δ) seconds, and (t1+2Δ) seconds. Reference numerals 411 and 412 denote locations of the mobile object 20, which is an image capturing target, in the image capturing scenes, and reference numerals 421, 422, and 423 denote locations of a mobile object other than the image capturing target in the image capturing scenes. Reference numerals 431, 432, and 433 denote the image capturing field angle of the image capturing device 15 in the respective image capturing scenes, and reference numerals 441, 442, and 443 denote images captured by the image capturing device 15 in the respective image capturing scenes.

When the captured image 441 is obtained in the step S301, the mobile object detection unit 17 detects that the image capturing field angle 431 includes the whole of the mobile object 20 at the location 411 and sends the detection result to the instruction determination unit 35 (YES in the step S302). When receiving the detection result, the instruction determination unit 35 determines that the image capturing desired by the user is performed and that it is not necessary to issue an instruction relating to the steering to the mobile object 20, and maintains the current travel control of the mobile object 20 and continues the image capturing by the image capturing device 15 (the step S307).

On the other hand, when the captured image 442 is obtained in the step S301, the mobile object detection unit 17 detects the image capturing field angle 432 includes only a portion of the mobile object 20 at the location 412 (NO in the step S302) and sends the detection result to the instruction determination unit 35. When receiving the detection result, the instruction determination unit 35 determines that the image capturing desired by the user is not performed and that it is necessary to issue an instruction related to the steering to the mobile object 20, and instructs the image capturing device 15 to stop the image capturing (the step S302a), and proceeds with the process to the step S303. The step S302a corresponds to a reception step of receiving, from the mobile image capturing apparatus 10, the detection result indicating whether the whole of the mobile object 20 is included in the image capturing field angle of the mobile image capturing apparatus 10.

In addition, when the captured image 443 is obtained in the step S301, the mobile object detection unit 17 detects the image capturing target (the mobile object 20) does not exist in the image capturing field angle 433 (NO in the step S302), and transmits the detection result to the instruction determination unit 35. When receiving the detection result, the instruction determination unit 35 determines that the image capturing desired by the user is not performed and that it is necessary to issue an instruction relating to the steering to the mobile object 20, instructs the image capturing device 15 to stop the image capturing (the step S302a), and proceeds with the process to the step S303.

Referring back to FIG. 3, in the step S303, the instruction determination unit 35 obtains the traveling information of the mobile object 20 from the mobile object 20. The traveling information obtained here includes the traveling characteristic and the information about the operation obtained from the traveling information obtaining module 201 of the mobile object 20, the information about the location obtained from the location information obtaining module 204 of the mobile object 20, and the like. These pieces of information are transmitted from the communication unit 26 of the mobile object 20 to the communication unit 36 of the instruction device 30.

Next, in a step S304, the instruction determination unit 35 obtains the information about the image capturing and the flight of the mobile image capturing apparatus 10 from the mobile image capturing apparatus 10. The information about the image capturing and the flight obtained here includes the information about the altitude and the acceleration obtained by the movement controller 14, the information about the image capturing location estimated by the location-and-orientation estimation unit 16, and the information about a moving speed, the moving direction, and the future moving route. These pieces of information are transmitted from the communication unit 19 of the mobile image capturing apparatus 10 to the communication unit 36 of the instruction device 30.

Next, in a step S305, the instruction determination unit 35 determines an instruction related to the steering of the mobile object 20 based on the traveling information about the mobile object 20 obtained in the step S303 and the information related to the image capturing and the flight of the mobile image capturing apparatus 10 obtained in the step S304. Specifically, the instruction determination unit 35 determines the steering instruction required to put the whole of the mobile object 20 in the image capturing field angle of the image capturing device 15 based on the obtained information, and transmits the steering instruction to the mobile object 20 via the communication unit 36. The step S305 corresponds to an instruction step of giving an instruction relating to the steering of at least one of the mobile object 20 and the mobile image capturing apparatus 10 in accordance with the detection result.

The determination of the instruction related to the steering of the mobile object 20 by the instruction determination unit 35 in the step S305 will now be described using the examples shown in FIGS. 4A, 4B, and 4C.

When a part of the mobile object 20 is included in the image capturing field angle 432 as in the captured image 442, the instruction determination unit 35 first calculates the speed difference between the mobile image capturing apparatus 10 and the mobile object 20 from the information obtained in the steps S303 and S304. Next, the instruction determination unit 35 calculates a distance between the mobile image capturing apparatus 10 and the mobile object 20 in the horizontal direction based on the location information about the mobile image capturing apparatus 10 and the mobile object 20 obtained in the steps S303 and S304. When the calculated distance falls within a first threshold, the instruction determination unit 35 determines that the whole of the mobile object 20 can be included in the image capturing field angle by decelerating the mobile object 20, and calculates a deceleration amount of the mobile object 20 from the calculated speed difference and distance. Thereafter, the instruction determination unit 35 transmits the steering instruction for decelerating the mobile object 20 together with the calculated deceleration amount to the mobile object 20.

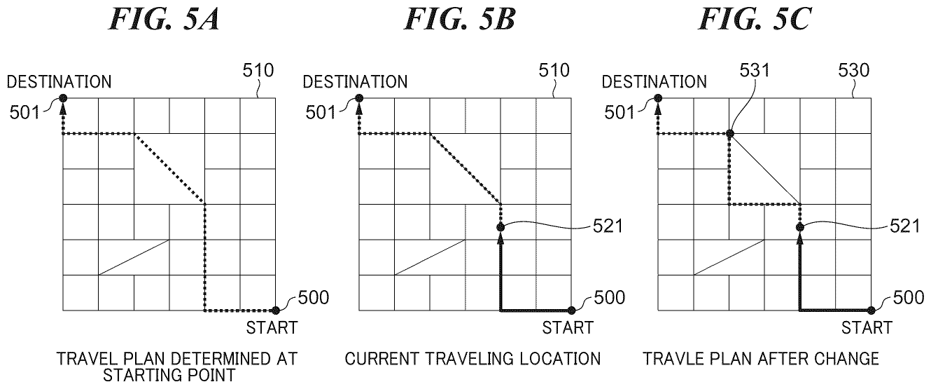

On the other hand, when the image capturing object (the mobile object 20) is not present in the image capturing field angle 433 as in the captured image 443, the instruction determination unit 35 calculates the distance in the horizontal direction between the mobile image capturing apparatus 10 and the mobile object 20 based on the pieces of location information obtained in the steps S303 and S304. When the calculated distance is equal to or more than a second threshold, which is more than the first threshold, the instruction determination unit 35 determines that the whole of the mobile object 20 cannot be included in the image capturing field angle even if the mobile object 20 is decelerated and transmits the steering instruction to change the route to the destination of the mobile object 20 to the mobile object 20. In accordance with the steering instruction, the automatic traveling ECU 24 of the mobile object 20 determines a new route and a speed in a step S306, which will be described later. That is, a predetermined meeting point with the mobile image capturing apparatus 10 is determined based on the current travel plan of the mobile object 20, and the route and speed are determined so that the mobile object 20 will arrive at the meeting point at the time when the mobile image capturing apparatus 10 is expected to arrive at the meeting point. The specific process will be described with reference to FIGS. 5A, 5B, and 5C.

FIG. 5A shows a travel plan 510 planned at the start of the travel from a travel start location 500 to a destination 501. Also, FIG. 5B shows a location 521 of the mobile object 20 at the time when the mobile image capturing apparatus 10 loses track of the mobile object 20. FIG. 5C shows a predetermined meeting point 531 determined and a travel plan 530 after the route change.

First, when a user sets, at the travel start location 500, the destination 501 of the mobile object 20, the automatic traveling ECU 24 determines the travel plan (a route indicated by a dotted line in the travel plan 510) from the travel start location 500 to the destination 501. Thereafter, the mobile object 20 moves along the determined travel plan in accordance with the steering instruction by the automatic traveling ECU 24.

During the movement, when the mobile object 20 at the location 521 deviates from the image capturing field angle of the mobile image capturing apparatus 10 at the image capturing time (t1+2Δ) seconds, the instruction determination unit 35 calculates the distance in the horizontal direction between the mobile image capturing apparatus 10 and the mobile object 20. When the calculated distance is equal to or more than the second threshold, the instruction determination unit 35 determines that it is necessary to determine a predetermined meeting point of the mobile image capturing apparatus 10 and the mobile object 20, and to change the travel plan of the mobile object 20.

Specifically, the instruction determination unit 35 now defines the predetermined meeting point 531, determines a new travel plan of the mobile object 20 (a route shown by a dotted line in the travel plan 530) from the location 521, and moves the mobile object 20 along this new travel plan from the location 521. On the other hand, the mobile image capturing apparatus 10 is moved along the route of the original travel plan. Thus, the mobile object 20 and the mobile image capturing apparatus 10 can meet at the predetermined meeting point 531.

Referring back to FIG. 3, in the next step S306, the automatic traveling ECU 24 executes the following process. First, the instruction information obtaining module 205 obtains the information about the steering instruction transmitted in the step S305 from the instruction device 30. Next, when the travel control module 206 obtains the information about the steering instruction from the instruction information obtaining module 205, the travel control module 206 changes an automatic traveling control content in consideration of the information obtained from the traveling information obtaining module 201, the peripheral information obtaining module 202, the map information obtaining module 203, and the location information obtaining module 204. When the travel control module 206 transmits the changed automatic traveling control content to the driving mechanism 25, the driving mechanism 25 changes the travel control of the mobile object 20 in accordance with the automatic traveling control content. Thereafter, the process proceeds to a step S308.

For example, there is a case where the instruction information obtaining module 205 obtains the information about the steering instruction that decelerates the mobile object 20, and the peripheral information obtaining module 202 obtains information showing that there is no other mobile object in the periphery or a relative distance to another mobile object is long. In this case, the travel control module 206 determines that the speed of the mobile object 20 may be reduced and determines a deceleration amount within a range that does not violate the traffic rule obtained from the map information obtaining module 203 based on the current speed information obtained from the traveling information obtaining module 201. Thereafter, the travel control module 206 transmits the determined deceleration amount as the travel control signal (the automatic traveling control content) to the driving mechanism 25 and notifies the instruction device 30 that the travel control after the change has been started. When receiving the travel control signal, the driving mechanism 25 controls the traveling of the mobile object 20. The travel control module 206 may notify the instruction device 30 of the determined deceleration amount of the mobile object 20.

For example, when the instruction information obtaining module 205 obtains the information about the steering instruction to change the route to the destination, the travel control module 206 determines that the travel plan to the destination in the automatic traveling currently being executed needs to be changed. In this case, the travel control module 206 re-searches for a route to the destination based on the map information obtained from the map information obtaining module 203 and the current location information of the mobile object 20 obtained from the location information obtaining module 204. In this re-search, a detour route of the mobile object 20 that enables the mobile image capturing apparatus 10 to catch up with the mobile object 20 at a predetermined point when the mobile image capturing apparatus 10 traces the travel plan before the change is searched for. Then, the travel control module 206 changes the travel plan to the searched detour route and determines the steering instruction such as a steering wheel operation to travel along the route after the change. Thereafter, the travel control module 206 transmits the determined steering instruction to the driving mechanism 25 as the travel control signal (the automatic traveling control content) and notifies the instruction device 30 that the travel control after the change has been started. When receiving the travel control signal, the driving mechanism 25 controls the traveling of the mobile object 20.

Next, when receiving the notification from the travel control module 206, the instruction determination unit 35 determines that the mobile object 20 will be included in the image capturing field angle of the mobile image capturing apparatus 10, instructs the mobile image capturing apparatus 10 to restart the image capturing in the step S308, and then returns the process to the step S301.

In the information processing system 100 according to this embodiment, the instruction device 30 is described as a device different from the mobile image capturing apparatus 10 and the mobile object 20, but may be included in the mobile image capturing apparatus 10. Specifically, the instruction device 30 may be eliminated from the information processing system 100, and the instruction determination unit may be incorporated into the mobile image capturing apparatus 10 instead. In this case, the instruction determination unit obtains the traveling characteristics of the mobile object 20, information regarding operations, information about a location, and the like from the mobile object 20, and determines an instruction related to the steering to the mobile object 20. Then, the mobile image capturing apparatus 10 transmits the instruction regarding the determined steering to the mobile object 20 via the communication unit 19 of the mobile image capturing apparatus 10.

The instruction determination unit may also be included in the mobile object 20. Specifically, the instruction device 30 may be eliminated from the information processing system 100, and the instruction determination unit may be incorporated into the mobile object 20 instead. In this case, the instruction determination unit obtains information related to the image capturing and flight from the mobile image capturing apparatus 10 and determines a steering instruction to the mobile object 20. Then, the steering instruction determined is transmitted to the travel control module 206 via the instruction information obtaining module 205.

Although the information processing system 100 according to this embodiment controls the traveling of the mobile object 20 so that the mobile object 20 will be included in the image capturing field angle of the image capturing device 15 (frame-in), the traveling of the mobile object 20 may be controlled according to an image capturing scenario determined in advance. Specifically, the image capturing scenario describes the image capturing condition and the location-and-orientation condition of the mobile image capturing apparatus 10 to obtain a desired image capturing cut that are determined on the basis of a written instruction regarding the image capturing and editing in which a configuration and a production of a moving image are written. If the image capturing according to the image capturing scenario by the image capturing device 15 cannot be performed due to the movement of the mobile object 20 during the image capturing according to the image capturing scenario, the traveling of the mobile object 20 is controlled so as to perform the desired image capturing.

For example, there is a case where, during the image capturing by the image capturing device 15 according to the image capturing scenario to obtain an image capturing cut in which the mobile image capturing apparatus 10 and the mobile object 20 run in parallel, the image capturing according to the scenario cannot be performed, that is, the mobile object 20 deviates from the image capturing field angle (NO in the step S302). In this case, the stop of the image capturing is instructed (the step S302a), and the process from the step S303 is executed. Specifically, first, the relative speed of the mobile image capturing apparatus 10 and the mobile object 20 in the horizontal direction is calculated based on an image capturing location and a moving speed obtained from the mobile image capturing apparatus 10 and a traveling location of the mobile object 20. Next, a traveling speed of the mobile object 20 is determined based on the calculated relative speed. Then, the image capturing can be performed according to the image capturing scenario by controlling the traveling of the mobile object 20 to be the determined speed.

As another example, there is a case where, during the image capturing by the image capturing device 15 according to the image capturing scenario to obtain an image capturing cut that causes the mobile object 20 to be framed out from the field angle of the image capturing device 15 in order to create a joint for editing, the image capturing according to the scenario cannot be performed (NO in the step S302). That is, the mobile object 20 is not framed out from the field angle. In this case, the stop of the image capturing is instructed (the step S302a), and the process from the step S303 is executed. Specifically, first, an acceleration amount that causes the mobile object 20 detected to be included in the field angle of the image capturing device 15 to frame out is calculated based on the image capturing location and the moving speed obtained from the mobile image capturing apparatus 10 and the traveling location of the mobile object 20. Then, the image capturing according to the image capturing scenario can be performed by controlling the traveling of the mobile object 20 to be the calculated acceleration amount.

Although the information processing system 100 in this embodiment has been described with respect to the instructions relating to the steering of the mobile object 20 (control instructions relating to travel), the instructions may include other operation control instructions for the mobile object 20. Here, the other operation control instructions include light control instructions for lamps, such as blinkers and headlamps, included in the mobile object 20, operation control instructions for movable mechanisms, such as opening and closing instructions for windows and a driving instruction for a wiper. For example, when the blinking of the blinker in turning at an intersection is captured, it is necessary to blink the blinker when the lamp of the blinker of the mobile object 20 is included in the field angle of the image capturing device 15. In this case, it is determined whether the lamp of the blinker of the mobile object 20 is included in the field angle of the image capturing device 15 at the timing immediately before the mobile object 20 arrives at the intersection at which the mobile object 20 is scheduled to turn on the basis of the image capturing location, the image capturing direction, and the captured image obtained from the mobile image capturing apparatus 10. When the lamp of the blinker is included in the field angle at this timing, the mobile object 20 is controlled to blink the lamp of the blinker. Thus, a desired image capturing cut in which the blinker of the mobile object 20 blinks in turning at the intersection can be obtained.

Hereinafter, an information processing system 100-2 according to a second embodiment of the present invention will be described. In this embodiment, the components same as those of the information processing system 100 according to the first embodiment are denoted by the same reference numerals, and the duplicated descriptions will be omitted.

The information processing system 100-2 of the second embodiment differs from that of the first embodiment in that a manual mobile object 40 that is manually operated by an operator (a user) by means of a steering wheel, a brake pedal, an accelerator pedal, etc. (hereinafter referred to as an operation unit 47) instead of the mobile object 20.

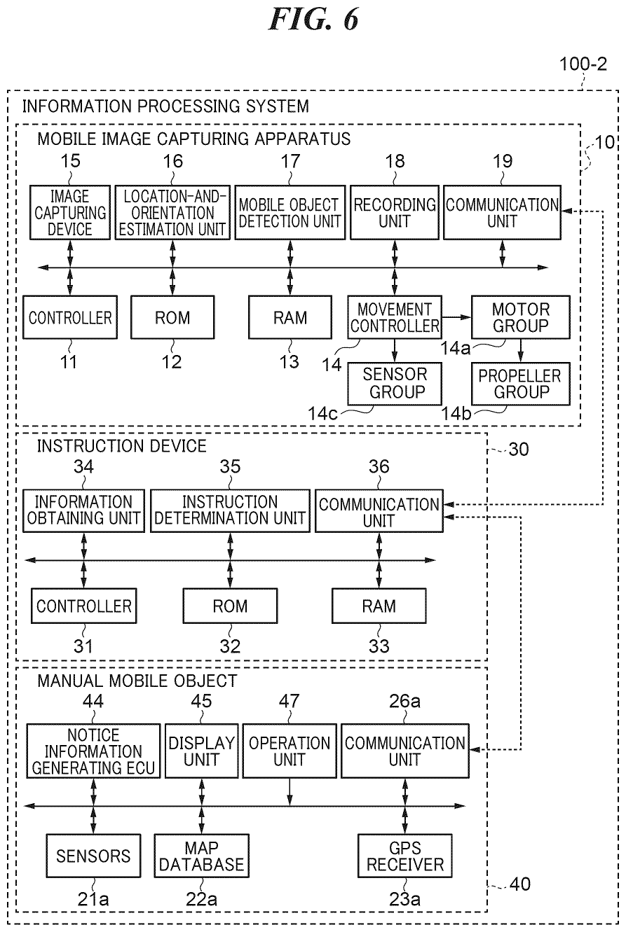

FIG. 6 is a block diagram showing a hardware configuration of the information processing system 100-2 according to this embodiment. In the manual mobile object 40 in FIG. 6, blocks that execute the same processes as the blocks in the mobile object 20 in FIG. 1 are denoted by the same reference numerals with “a” suffixed thereto.

As compared with the mobile object 20 in FIG. 1, the manual mobile object 40 differs in having a notice information generating ECU 44 and a display unit 45. Therefore, the process contents of the notice information generating ECU 44 and the display unit 45, which are characteristics in this embodiment, will be described in detail below.

The notice information generating ECU 44 (a notification unit) is an electronic controller including a CPU, a ROM, a RAM, a CAN communication circuit, and the like, and displays a signal in accordance with the notice information on the display device 45 by controlling the hardware based on a signal output by the CPU. As an example of a specific operation, the CAN communication circuit is operated to store data obtained from a sensor group 21a, a map database 22a, and a communication unit 26a in the RAM as input data. Thereafter, the notice information generating ECU 44 determines the notice information based on the input data by running a program loaded to the RAM from the ROM and transmits a signal in accordance with the determined notice information to the display unit 45. Details of the process will be described later.

The display unit 45 is built in the manual mobile object 40 and displays signals from the notice information generating ECU 44 to inform the operator. Here, the display unit 45 can use a known display, such as a liquid crystal display, a plasma display, or an organic EL display, as a display screen.

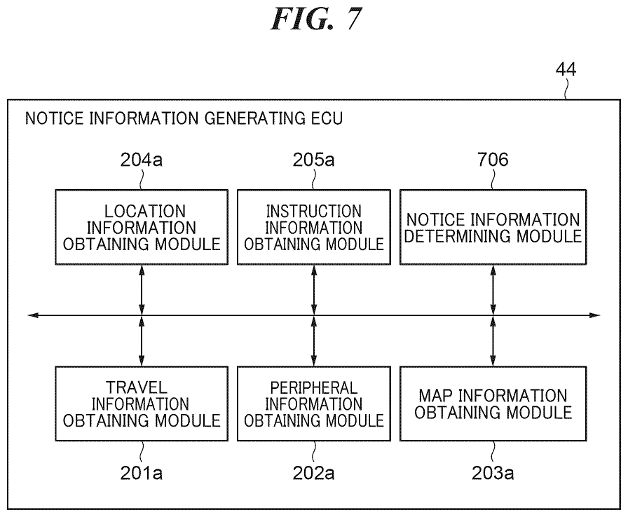

FIG. 7 is a block diagram showing a software configuration of the notice information generating ECU 44.

In FIG. 7, blocks that execute the same processes as the blocks in the software configuration of the automatic traveling ECU 24 in FIG. 2 are denoted by the same reference numerals with “a” suffixed thereto. The software configuration in FIG. 7 differs from that in FIG. 2 in that the notice information determining module 706 is provided instead of the travel control module 206. Therefore, the process contents of the notice information determining module 706 that are characteristics of this embodiment will be described in detail below.

In the notice information determining module 706, information regarding the notification to the operator of the manual mobile object 40 is determined based on the information obtained from the sensor group 21a, the map database 22a, and the communication unit 26a. The signal related to the notification determined in the notice information determining module 706 is transmitted to the display unit 45. This process will be described in detail later.

Here, the operation of the notice information determining module 706 in the image capturing process in this embodiment and the operations of the mobile image capturing apparatus 10 and the instruction device 30 required in association with the operation of the notice information determining module 706 will be described.

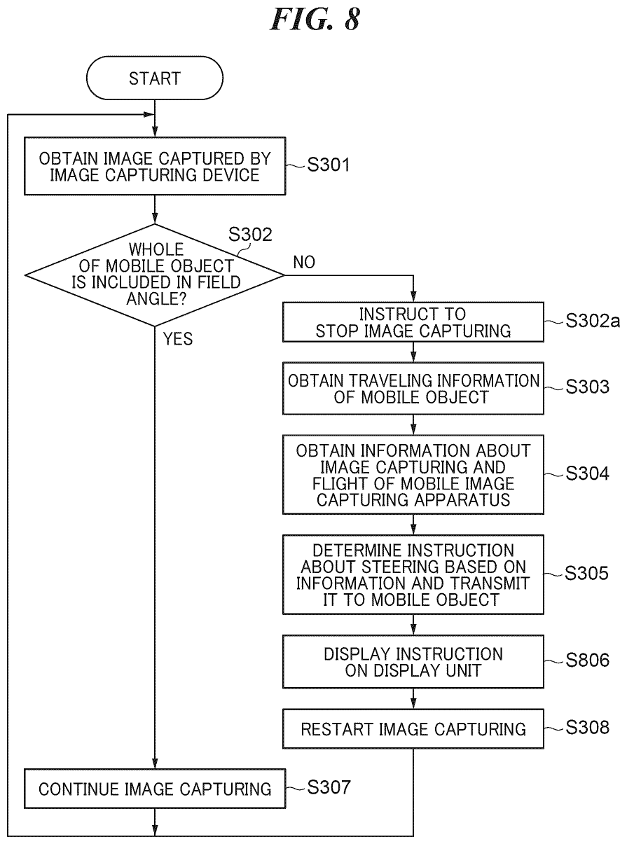

FIG. 8 is a flowchart schematically showing the image capturing process in the information processing system 100-2 in this embodiment. In FIG. 8, the same step numbers are assigned to steps for executing the same processes as in the flowchart in FIG. 3. The flowchart in FIG. 8 differs from that in FIG. 3 in that a process in a step S806 is performed instead of the process in the step S306. The process contents of the step S806, which are characteristics in this embodiment, will be described in detail below.

In the step S806, the following process is executed by the notice information generating ECU 44. First, the instruction information obtaining module 205a obtains the information of the steering instruction transmitted from the instruction device 30 in the step S305 in FIG. 8 through the communication unit 26a of the manual mobile object 40. Next, the notice information determining module 706 determines the notice information for the operator by adding the information obtained from the traveling information obtaining module 201a, the peripheral information obtaining module 202a, the map information obtaining module 203a, and the location information obtaining module 204a to the information about the steering instruction obtained by the instruction information obtaining module 205a. Thereafter, when the notice information determining module 706 transmits the determined notice information to the display unit 45, the display device 45 displays the notice information.

For example, when the instruction information obtaining module 205a obtains the information about the steering instruction to decelerate the manual mobile object 40, there is a case where the peripheral information obtaining module 202a obtains the periphery information showing that there is no other mobile object in the periphery or a relative distance to another mobile object is long. In this case, the notice information determining module 706 determines that the speed may be reduced and determines a deceleration amount within a range that does not violate the traffic rule acquired from the map information obtaining module 203a based on the current speed information obtained from the traveling information obtaining module 201a. Thereafter, the notice information determining module 706 transmits the determined deceleration amount to the display unit 45 as the notice information, and notifies the instruction device 30 that the travel control after the change has been started. When receiving the notice information, the display unit 45 displays the notice information.

For example, when the instruction information obtaining module 205a obtains the information about the steering instruction to change the route to the destination, the notice information determining module 706 determines that the currently set travel plan to the destination needs to be changed. In this case, the notice information determining module 706 re-searches for a route to the destination based on the map information obtained from the map information obtaining module 203a and the current location information of the manual mobile object 40 obtained from the location information obtaining module 204a. In this re-search, a detour route of the manual mobile object 40 that enables the mobile image capturing apparatus 10 to catch up with the manual mobile object 40 at a predetermined point when the mobile image capturing apparatus 10 traces the travel plan before the change is searched for. Then, the notice information determining module 706 changes the travel plan to the searched detour route, transmits the route after the change as the notice information to the display unit 45, and notifies the instruction device 30 that the travel control after the change has been started. When receiving the notice information, the display unit 45 displays the notice information.

Hereinafter, an information processing system according to a third embodiment of the present invention will be described. In this embodiment, the components same as those of the information processing system 100 according to the first embodiment are denoted by the same reference numerals, and the duplicated descriptions will be omitted.

The information processing system in the third embodiment differs from that in the first embodiment in that the movement of the mobile image capturing apparatus 10 is also controlled in addition to control the movement of the mobile object 20. More specifically, this embodiment is greatly different from the first embodiment in that the instruction determination unit 35 in the instruction device 30 determines an instruction related to the steering of the mobile image capturing apparatus 10 and the determined instruction is transmitted from the communication unit 36 to the communication unit 19 of the mobile image capturing apparatus 10.

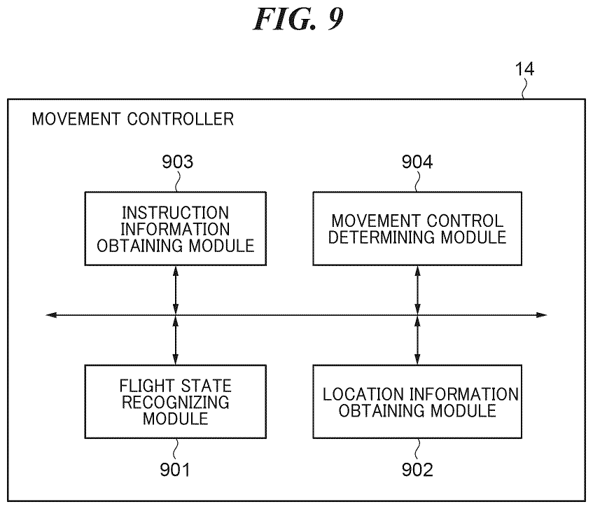

FIG. 9 is a block diagram showing a software configuration of the movement controller 14 of the mobile image capturing apparatus 10 according to this embodiment.

The movement controller 14 in this embodiment includes a flight state recognizing module 901, a location information obtaining module 902, an instruction information obtaining module 903, and a movement control determining module 904.

In order to recognize the flight state of the mobile image capturing apparatus 10, the flight state recognizing module 901 detects pieces of information, such as the altitude and the acceleration, and an object in the periphery of the mobile image capturing apparatus 10 using the sensor group 14c (the atmospheric pressure sensor, the acceleration sensor, the LiDAR, etc.).

The location information obtaining module 902 obtains information regarding the image capturing detected by the location-and-orientation estimation unit 16. The information about the image capturing includes an image capturing location, a moving speed, a moving direction, and a future moving route of the mobile image capturing apparatus 10.

The instruction information obtaining module 903 obtains information regarding the steering of the mobile image capturing apparatus 10 from the communication unit 19. The information about the steering of the mobile image capturing apparatus 10 includes the acceleration, the deceleration, and the change of the route to the destination of the mobile image capturing apparatus 10.

Then, the movement control determining module 904 determines the movement control information for the mobile image capturing apparatus 10 based on the information obtained from the sensor group 14c, a database (not shown) held in the ROM 12, and the communication unit 19. Based on the determined movement control information, the movement control determining module 904 controls the driving forces of the four motors constituting the motor group 14a to control the rpms of the four propellers constituting the propeller group 14b in order to control the moving direction, the location, and the orientation of the mobile image capturing apparatus 10.

Here, the operation of the movement control determining module 904 in the image capturing process in this embodiment and the operations of the mobile image capturing apparatus 10 and the instruction device 30 required in association with the operation of the movement control determining module 904 will be described.

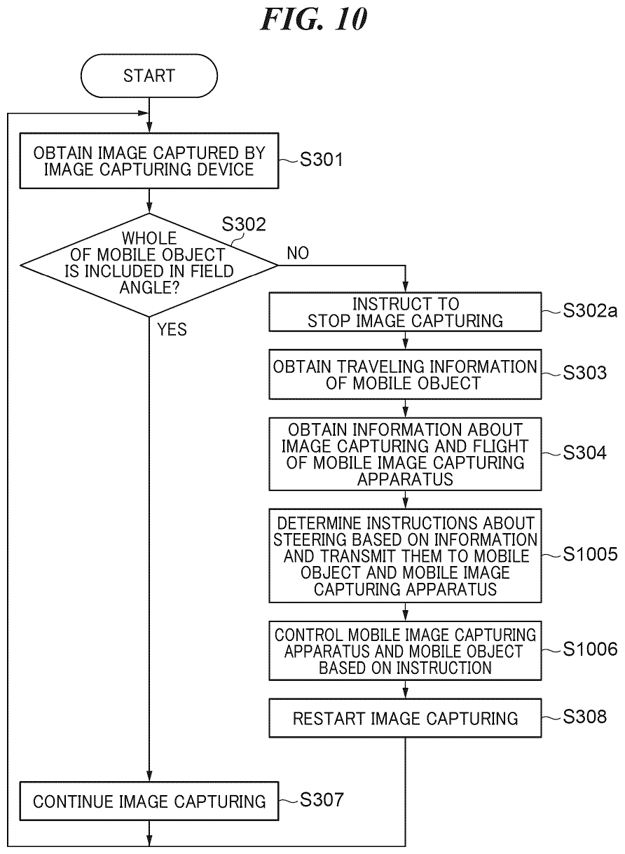

FIG. 10 is a flowchart schematically showing the image capturing process in the information processing system in this embodiment. In FIG. 10, the same step numbers are assigned to steps for executing the same processes as in the flowchart in FIG. 3. The flowchart in FIG. 10 differs from that in FIG. 3 in that processes in steps S1005 and S1006 are performed instead of the processes in the steps S305 and S306. The process contents of the steps S1005 and S1006, which are characteristics in this embodiment, will be described in detail below.

In the step S1005, the instruction determination unit 35 of the instruction device 30 determines the instruction(s) related to the steering based on the traveling information of the mobile object 20 obtained in the step S303 and the information related to the image capturing and the flight of the mobile image capturing apparatus 10 obtained in the step S304. Specifically, the instruction device 30 determines the steering instruction(s) required to put the whole of the mobile object 20 in the image capturing field angle of the image capturing device 15 based on the obtained information, and transmits the steering instruction(s) to at least one of the mobile object 20 and the mobile image capturing apparatus 10.

Here, the determination of the instructions regarding the steering by the instruction determination unit 35 in the step S1005 will be described using the concrete examples shown in FIGS. 4A, 4B, and 4C.

When a part of the mobile object 20 is included in the image capturing field angle 432 as in the captured image 442, the instruction determination unit 35 first calculates the speed difference between the mobile image capturing apparatus 10 and the mobile object 20 from the information obtained in the steps S303 and S304. Next, the instruction determination unit 35 calculates the distance between the mobile image capturing apparatus 10 and the mobile object 20 in the horizontal direction based on the location information of the mobile image capturing apparatus 10 and the mobile object 20 obtained in the steps S303 and S304. If the calculated distance falls within the first threshold, the instruction determination unit 35 determines that the whole of the mobile object 20 can be included in the image capturing field angle by reducing the relative speed between the mobile object 20 and the mobile image capturing apparatus 10. Further, since another mobile object, which is not the image capturing target, at the position 422 is in the close range, it is difficult to decelerate the mobile object 20, and thus the instruction determination unit 35 determines that the relative speed can be reduced by accelerating the mobile image capturing apparatus 10. Based on this determination, the instruction determination unit 35 calculates the acceleration amount of the mobile image capturing apparatus 10 from the calculated distance and speed difference. The instruction determination unit 35 then transmits the steering instruction to the mobile image capturing apparatus 10 which accelerates the mobile image capturing apparatus 10 with the calculated acceleration amount.

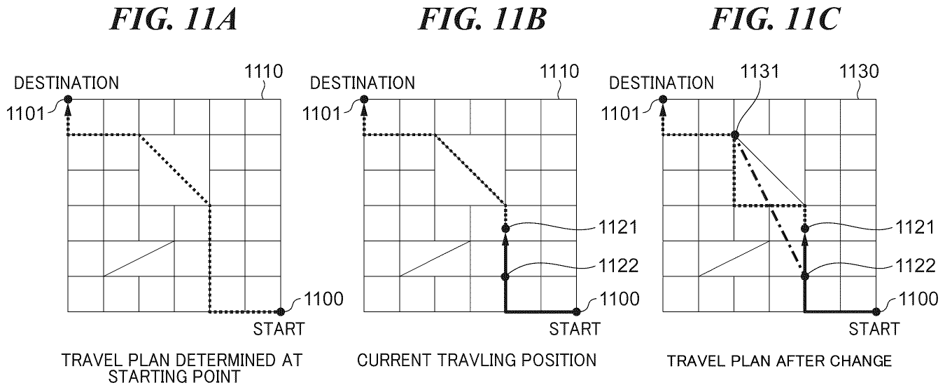

On the other hand, when the image capturing target (the mobile object 20) is not present in the image capturing field angle 433 as in the captured image 443, the instruction determination unit 35 calculates the distance between the mobile image capturing apparatus 10 and the mobile object 20 in the horizontal direction based on the respective pieces of the location information obtained in the steps S303 and S304. When the calculated distance is equal to or more than the second threshold, which is more than the first threshold, the instruction determination unit 35 determines that the whole of the mobile object 20 cannot be included in the image capturing field angle even if the speed of the mobile object 20 is reduced. Further, when the calculated distance is equal to or more than a third threshold, which is more than the second threshold, the instruction determination unit 35 determines that the whole of the mobile object 20 cannot be included in the image capturing field angle even if only the route of the mobile object 20 is changed. Based on this determination, the instruction determination unit 35 transmits the steering instructions to change the respective routes to the destination to both of the mobile object 20 and the mobile image capturing apparatus 10. In accordance with the steering instructions, the automatic traveling ECU 24 of the mobile object 20 and the movement controller 14 of the mobile image capturing apparatus 10 determine new routes and speeds in the step S1006 described later. That is, a predetermined meeting point with the mobile image capturing apparatus 10 is determined from the current travel plan of the mobile object 20, and the route and speed are determined so that the mobile object 20 also arrives at the meeting point at the time when the mobile image capturing apparatus 10 is expected to arrive at the meeting point. A specific process will be described with reference to FIGS. 11A, 11B, and 11C.

FIG. 11A shows a travel plan 1110 planned at the start of the travel from a travel start location 1100 to a destination 1101. Also, FIG. 11B shows a location 1121 of the mobile object 20 and a location 1122 of the mobile image capturing apparatus 10 at the time when the mobile image capturing apparatus 10 loses track of the mobile object 20. Further, FIG. 11C shows a predetermined meeting point 1131 determined and a travel plan 1130 after the route change.

First, when a user sets, at the travel start location 1100, the destination 1101 of the mobile object 20, the automatic traveling ECU 24 determines the travel plan (a route indicated by a dotted line in the travel plan 1110) from the travel start location 1100 to the destination 1101. Thereafter, the mobile object 20 moves along determined travel plan in accordance with the steering instruction by the automatic traveling ECU 24.

During the movement, when the mobile image capturing apparatus 10 at the location 1122 is no longer able to detect the mobile object 20 at the location 1121, the instruction determination unit 35 calculates the distance in the horizontal direction between the mobile image capturing apparatus 10 and the mobile object 20. When the distance calculated here is equal to or more than the third threshold, the instruction determination unit 35 determines a predetermined meeting point between the mobile image capturing apparatus 10 and the mobile object 20 and determines that the travel plan of the mobile object 20 and the mobile image capturing apparatus 10 needs to be changed.

Specifically, the instruction determination unit 35 defines the predetermined meeting point 1131, determines a new travel plan of the mobile object 20 (a route indicated by a dotted line in the travel plan 1130) from the location 1121, and moves the mobile object 20 from the location 1121 along this new travel plan. On the other hand, when the mobile image capturing apparatus 10 moves along the route of the original flight plan, the mobile image capturing apparatus 10 cannot meet the mobile object 20 at the predetermined meeting point 1131. Therefore, the instruction determination unit 35 determines a new travel plan (a route indicated by an alternate long and short dash line in the travel plan 1130) from the location 1122 of the mobile image capturing apparatus 10, and moves the mobile image capturing apparatus 10 from the location 1122 along this new travel plan. Thus, the mobile object 20 and the mobile image capturing apparatus 10 can meet at the predetermined meeting point 531.

Referring back to FIG. 10, in the next step S1006, the automatic traveling ECU 24 of the mobile image capturing apparatus 10 executes the process similar to the process in the step S306. On the other hand, the movement controller 14 of the mobile image capturing apparatus 10 executes the following process.

First, the instruction information obtaining module 903 obtains the information about the steering instruction transmitted from the instruction device 30 in the step S1005. Next, when obtaining the information about the steering instruction from the instruction information obtaining module 903, the movement control determining module 904 changes the flight control content in consideration of the information obtained from the flight state recognizing module 901 and the location information obtaining module 902. Thereafter, the movement control determining module 904 controls the driving of the motor group 14a and the propeller group 14b in accordance with the flight control content after the change.

For example, there is a case where the flight state recognizing module 901 obtains information showing that there is no other mobile object in the periphery or a relative distance to another mobile object is long when the instruction information obtaining module 903 obtains the information about the steering instruction that accelerates the mobile image capturing apparatus 10. In this case, the movement control determining module 904 determines that the speed of the mobile image capturing apparatus 10 may be increased and determines the acceleration amount based on the current speed information obtained from the location information obtaining module 902. Thereafter, the movement control determining module 904 controls the driving of the motor group 14a and the propeller group 14b based on the determined acceleration amount and notifies the instruction device 30 that the flight control after the change has been started. The movement control determining module 904 may notify the instruction device 30 of the determined acceleration amount of the mobile image capturing apparatus 10 together.

For example, when the instruction information obtaining module 903 obtains the information about the steering instruction to change the route to the destination, the movement control determining module 904 determines that the current flight plan to the destination needs to be changed. In this case, the movement control determining module 904 re-searches for a route to the destination based on the current location information of the mobile image capturing apparatus 10 obtained from the location information obtaining module 902. In this re-search, the shortest route to the meeting point with the mobile object 20 is searched for. Thereafter, the movement control determining module 904 changes the flight plan to the shortest route that has been searched, controls the driving of the motor group 14a and the propeller group 14b so as to proceed along the route after the change, and notifies the instruction device 30 that the flight control after the change has been started.

In the information processing system according to this embodiment, since there is the mobile object other than the image capturing target in the close range of the mobile object 20, it is determined that it is difficult to decelerate the mobile object 20 in the step S1005, and the mobile image capturing apparatus 10 is controlled to be accelerated. However, other control methods in a case where the steering control of the mobile object 20 or the mobile image capturing apparatus 10 is limited may be considered. Which control method is prioritized when a plurality of control methods are considered is determined according to which control method is performed to restart the image capturing earlier, whether the control for the mobile image capturing apparatus 10 or the mobile object 20 is prohibited, or the like. For example, in the case of the mobile object 20, it is considered whether the traveling speed falls within a range in which safe steering is possible, whether there is a speed limit in the traveling location, whether change of the travel control violates the traffic rule, and the like. In the case of the mobile image capturing apparatus 10, it is considered whether the flight speed after the change is a flight restriction target, whether there is no other object in the periphery, whether the flight speed after the change exceeds the speed limit of the mobile image capturing apparatus 10, and the like. When such a limitation is imposed, it is necessary to control the movement by assigning a priority order for the control methods.

On the other hand, when the image capturing according to the image capturing scenario cannot be performed during the image capturing according to the image capturing scenario (NO in the step S302), the instruction device 30 determines an instruction related to the steering of at least one of the mobile object 20 and the mobile image capturing apparatus 10 in the step S1005. However, there is a case where the steering control of at least one of the mobile image capturing apparatus 10 and the mobile object 20 is restricted, the steering control cannot be performed as instructed in the step S1006, and therefore the image capturing according to the image capturing scenario cannot be performed even after the instruction regarding the steering. In this case, the instruction device 30 may change the image capturing scenario and redetermine the instruction related to the steering for at least one of the mobile object 20 and the mobile image capturing apparatus 10 based on the image capturing scenario after the change. Specifically, the direction in which the mobile object 20 is captured may be changed. Alternatively, the focal length of the optical system of the image capturing device 15 may be changed by changing the image capturing condition of the mobile image capturing apparatus 10. In such a case, the captured image may be trimmed in the subsequent editing. Whether the image capturing according to the image capturing scenario can be performed even after the instruction regarding the steering is determined based on the conditions (the acceleration amounts, deceleration amounts, etc.) of the mobile image capturing apparatus 10 and the mobile object 20 obtained in the step S1006.

After changing the image capturing scenario, the instruction device 30 (the instruction determination unit 35) obtains the current states of the mobile image capturing apparatus 10 and the mobile object 20 as current information. Thereafter, when the instruction device 30 determines that the image capturing according to the image capturing scenario after the change can be performed based on the obtained current information, the instruction device 30 proceeds with the process to the step S308, and the instruction determination unit 35 instructs the mobile image capturing apparatus 10 to restart the image capturing. This shortens a period until restarting the image capturing in the mobile image capturing apparatus 10.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-200673, filed Nov. 28, 2023, which is hereby incorporated by reference herein in its entirety.

What is claimed is:

1. An information processing system comprising:
a mobile object;
a mobile image capturing apparatus that captures an image of the mobile object;
a memory device that stores a set of instructions; and
at least one processor that executes the set of instructions to:
receive a detection result indicating whether the mobile object is included in an image capturing field angle of the mobile image capturing apparatus from the mobile image capturing apparatus; and
issue an instruction relating to steering of at least one of the mobile object and the mobile image capturing apparatus in accordance with the detection result.

2. The information processing system according to claim 1, wherein the at least one processor executes the set of instructions to issues the instruction relating to the steering of at least one of the mobile object and the mobile image capturing apparatus in accordance with the detection result so that the whole of the mobile object will be included in the image capturing field angle of the mobile image capturing apparatus.

3. The information processing system according to claim 1, wherein the at least one processor executes the set of instructions to issues the instruction relating to the steering of at least one of the mobile object and the mobile image capturing apparatus in accordance with the detection result so that the mobile object is framed out from the image capturing field angle of the mobile image capturing apparatus.

4. The information processing system according to claim 1, further comprising a controller configured to control the mobile object,
wherein the controller controls a movement of the mobile object based on the instruction relating to the steering of the mobile object.

5. The information processing system according to claim 1, further 5. comprising further comprising a notification unit configured to notify an operator of the mobile object,
wherein the notification unit notifies the operator of information about the instruction related to the steering of the mobile object.

6. The information processing system according to claim 1, wherein the memory device and the at least one processor are incorporated into the mobile image capturing apparatus, and the mobile image capturing apparatus issues the instruction relating to the steering to the mobile object.

7. The information processing system according to claim 1, wherein the memory device and the at least one processor are incorporated into the mobile object, and the mobile object issues the instruction relating to the steering to the mobile image capturing apparatus.

8. The information processing system according to claim 1, wherein the instruction relating to the steering of the mobile object is an instruction to change a speed of the mobile object.

9. The information processing system according to claim 1, wherein the instruction relating to the steering of the mobile object is an instruction to change a route of the mobile object.

10. The information processing system according to claim 1, wherein the instruction related to the steering of the mobile image capturing apparatus is an instruction to change a route of the mobile image capturing apparatus.

11. The information processing system according to claim 1, wherein the instruction related to the steering of the mobile object includes a light control instruction for a lamp of the mobile object and an operation control instruction for a movable mechanism.

12. The information processing system according to claim 1, wherein the at least one processor executes the set of instructions to:
determine whether image capturing according to an image capturing scenario in which an image capturing condition and a location-and-orientation condition of the mobile image capturing apparatus to obtain a desired image capturing cut are described can be performed while the mobile image capturing apparatus performs the image capturing according to the image capturing scenario; and
issue the instruction relating to the steering in a case where it is determined that the image capturing according to the image capturing scenario cannot be performed.

13. The information processing system according to claim 1, wherein, in a case where image capturing according to an image capturing scenario in which an image capturing condition and a location-and-orientation condition of the mobile image capturing apparatus to obtain a desired image capturing cut are described cannot be performed while the mobile image capturing apparatus performs the image capturing according to the image capturing scenario even after issuing the instruction relating to the steering of at least one of the mobile object and the mobile image capturing apparatus because steering control of at least one of the mobile object and the mobile image capturing apparatus is restricted,
the at least one processor executes the set of instructions to:
change the image capturing scenario, and
redetermine an instruction relating to the steering of at least one of the mobile object and the mobile image capturing apparatus based on the image capturing scenario after change.

14. The information processing system according to claim 13, wherein the at least one processor executes the set of instructions to instruct the mobile image capturing apparatus to stop the image capturing in a case where the image capturing according to the image capturing scenario cannot be performed.

15. The information processing system according to claim 14, wherein 15. the at least one processor executes the set of instructions to:
obtain current states of the mobile image capturing apparatus and the mobile object as current information after the change of the image capturing scenario; and
instruct the mobile image capturing apparatus to restart the image capturing in a case where it is determined that the image capturing according to the image capturing scenario after the change can be performed based on the current information.

16. An information processing apparatus communicatively connected to a mobile object and a mobile image capturing apparatus that captures an image of the mobile object, the information processing apparatus comprising:
a memory device that stores a set of instructions; and
at least one processor that executes the set of instructions to:
receive a detection result indicating whether the mobile object is included in an image capturing field angle of the mobile image capturing apparatus from the mobile image capturing apparatus; and
issue an instruction relating to steering of at least one of the mobile object and the mobile image capturing apparatus in accordance with the detection result.

17. A control method for an information processing apparatus communicatively connected to a mobile object and a mobile image capturing apparatus that captures an image of the mobile object, the control method comprising:
receiving a detection result indicating whether the mobile object is included in an image capturing field angle of the mobile image capturing apparatus from the mobile image capturing apparatus; and
issuing an instruction relating to steering of at least one of the mobile object and the mobile image capturing apparatus in accordance with the detection result.

18. A non-transitory computer-readable storage medium storing a control program causing a computer to execute a control method for an information processing apparatus communicatively connected to a mobile object and a mobile image capturing apparatus that captures an image of the mobile object, the control method comprising:
receiving a detection result indicating whether the mobile object is included in an image capturing field angle of the mobile image capturing apparatus from the mobile image capturing apparatus; and
issuing an instruction relating to steering of at least one of the mobile object and the mobile image capturing apparatus in accordance with the detection result.
